(19) United States
(12) Patent Application Publication
(10) Pub. No.: US 2023/0369889 A1
(43) Pub. Date: Nov. 16, 2023

(54) POWER CONTROL DEVICE, POWER CONTROL METHOD, AND POWER CONTROL PROGRAM

(71) Applicant: IHI CORPORATION, Tokyo (JP)

(72) Inventors: Kenichi HAMAGUCHI, Tokyo (JP); Akinobu INAMURA, Tokyo (JP)

(73) Assignee: IHI CORPORATION, Tokyo (JP)

(21) Appl. No.: 18/129,241

(22) Filed: Mar. 31, 2023

(30) Foreign Application Priority Data
May 10, 2022 (JP) 2022-077480

(51) Int. Cl. H02J 13/00; H02J 3/32

(52) U.S. Cl. CPC H02J 13/00002; H02J 3/32; H02J 2203/20; H02J 2300/24

(57) ABSTRACT

Provided is a technique that stably adjusts energy exchange with an outside and quickly returns received power in a case in which a deviation between a target value and an actual value increases. A power control device controls an operation of a power adjustment device in a microgrid that is capable of exchanging energy with an outside and includes the power adjustment device adjusting an internal power usage. The power control device includes a control unit that controls the power adjustment device such that an actual value of the energy exchange with the outside is close to a target value and, in a case in which a state of the energy exchange changes such that a deviation between the target value and the actual value becomes larger, performs change control to change a content of control such that an amount of change in the deviation increases.

### CROSS-REFERENCE TO RELATED APPLICATIONS

This application claims the benefit of priority from Japanese Patent Application No. 2022-077480, tiled on May 10, 2022, the entire contents of which are incorporated herein by reference.

### TECHNICAL FIELD

The present disclosure relates to a power control device, a power control method, and a power control program.

### BACKGROUND

In the related art, control (hereafter, referred to as “constant power control”) that keeps tidal power flowing between a house, such as a microgrid, and a commercial system at a constant value using, for example, a storage battery, a power generator, or an electric heater has been performed. For example, Japanese Unexamined Patent Publication No. 2020-096510 discloses PID control as a constant power control method related to received power. Further, Japanese Unexamined Patent Publication No. 2020-167795 discloses a method that increases the output of a power generator in a case in which received power is less than a predetermined value and decreases the output of the power generator in a ease in which the received power is larger than the predetermined value.

However, in recent years, with the spread of renewable energy, constraint conditions related to system interconnection have become complicated. For example, in some cases, the transmission of power to a system (reverse power flow) is prohibited due to the available capacity of the system. As a means for preventing the reverse power flow when a state of the reverse power flow occurs, renewable energy power generation is suppressed, or the charging power of the storage battery is increased.

For example, Japanese Patent No. 6773204 discloses a method that adjusts the magnitude of alternating-current power flowing from an inverter circuit to a system in a case in which a tidal flow from the system is equal to or less than predetermined power. In addition, Japanese Patent No. 5179582 discloses a power control system that instructs each power demand facility to perform control for preventing reverse power flow in a case in which power from a system to a plurality of power demand facilities having storage batteries is less than a certain threshold value. Furthermore, Japanese Patent No. 5377435 discloses a device that performs charge control on a plurality of storage batteries, which are connected to a secondary side of a distribution transformer, on the basis of a difference between a current and a threshold value such that reverse power flow does not occur in a case in which the current flowing to the downstream side of the transformer is less than a predetermined threshold value, in addition, Japanese Patent No. 6372387 discloses charge and discharge control that temporarily lowers (undershoots) discharge power from a storage battery to be less than a target value when the discharge power from the storage battery flows backward into a system and increases power purchase, thereby reducing the average amount of reverse power flow to the system, in order to prevent the reverse power flow of the discharge power from the storage battery.

However, when both the constant power control and the control for preventing the reverse power flow are achieved using the method described in, for example, Japanese Unexamined Patent Publication No. 2020-096510 or Japanese Unexamined Patent Publication No. 2020-167795, it is necessary to set higher target received power. Therefore, an energy self-sufficiency rate of the microgrid can be reduced. For this reason, there is room for improvement in a method for quickly returning the received power when the state of power exchange with the outside changes while performing the constant power control.

### SUMMARY

The present disclosure has been made in view of the above problems, and an object of the present disclosure is to provide a technique that can stably adjust energy exchange with the outside and quickly return received power in a case in which a deviation between a target value and an actual value increases.

According to an aspect of the present disclosure, there is provided a power control device that controls an operation of a power adjustment device in a microgrid capable of exchanging energy with an outside, the microgrid including the power adjustment device adjusting an internal power usage. The power control device includes a control unit that controls the power adjustment device such that an actual value of the energy exchange with the outside is close to a target value and, in a case in which a state of the energy exchange changes such that a deviation between the target value and the actual value becomes larger, performs change control to change a content of control such that an amount of change in the deviation increases.

According to another aspect of the present disclosure, there is provided a power control method that controls an operation of a power adjustment device in a microgrid capable of exchanging energy with an outside, the microgrid including the power adjustment device adjusting an internal power usage. The power control method includes: controlling the power adjustment device such that an actual value of the energy exchange with the outside is close to a target value; and, in a case in which a state of the energy exchange changes such that a deviation between the target value and the actual value becomes larger, performing change control to change a content of control such that an amount of change in the deviation increases.

According to still another aspect of the present disclosure, there is provided a power control program that causes a computer to control an operation of a power adjustment device in a microgrid capable of exchanging energy with an outside, the microgrid including the power adjustment device adjusting an internal power usage. The power control program causes the computer to execute: controlling the power adjustment device such that an actual value of the energy exchange with the outside is close to a target value; and, in a case in which a state of the energy exchange changes such that a deviation between the target value and the actual value becomes larger, performing change control to change a content of control such that an amount of change in the deviation increases.

According to the power control device, the power control method, and the power control program, the power adjustment device is controlled such that the actual value of the energy exchange with the outside is close to the target value. Therefore, it is possible to stably adjust the energy exchange with the outside. In addition, in a case in which the state of the energy exchange changes such that the deviation between the target value and the actual value becomes larger, the change control is performed to change the content of the control such that the amount of change in the deviation increases. Therefore, in a case in which the deviation increases, it is possible to quickly return the received power.

The control unit may perform the Change control in a case in which the actual value is on a side where the energy exchange is switched with respect to the target value and the deviation between the target value and the actual value becomes larger.

In a case in which the actual value is on the side where the energy exchange is switched with respect to the target value, for example, the risk that the switching of the energy exchange will occur increases. Therefore, it is necessary to quickly return the received power in a case in which the deviation increases. Therefore, the above-described configuration makes it possible to adjust the energy exchange with the outside while suppressing the switching, of the energy exchange.

The change control may be control to change the content of the control to a second condition in a case in which the deviation between the target value and the actual value is larger than a threshold value.

This configuration makes it possible to change the content of the control to the second condition with a focus on the relationship between the deviation and the threshold value. Therefore, it is possible to more easily determine whether or not to perform the change control. In addition, it is possible to more easily perform, for example, the calculation of a control value when a command is issued to the power adjustment device.

The change control may be control to continuously change the content of the control according to the deviation between the target value and the actual value.

According to this configuration, for example, when the deviation increases, the content of the control is continuously changed with the increase in the deviation. Therefore, it is possible to perform feedback control under appropriate conditions corresponding to the magnitude of the deviation.

According to the present disclosure, it is possible to provide a technique that can stably adjust energy exchange with the outside and quickly return the received power in a case in which a deviation between a target value and an actual value increases.

### BRIEF DESCRIPTION OF THE DRAWINGS

FIG. 1 is a schematic diagram illustrating a power supply system according to an embodiment.

FIG. 2 is a block diagram describing the functions of an EMS.

FIG. 3 is a block diagram illustrating an example of the content of control by a control unit of the EMS.

FIG. 4 is a diagram illustrating settings of a change in power obtained by photovoltaic power generation in a simulation according to this embodiment.

FIG. 5 is a diagram describing simulation results according to this embodiment.

FIG. 6 is a diagram describing simulation results according to this embodiment.

FIG. 7 is a diagram describing simulation results according to this embodiment.

FIG. 8 is a diagram illustrating an example of a hardware configuration of the EMS.

FIG. 9 is a block diagram illustrating an example of a change in the content of the control by the control unit of the EMS.

FIG. 10 is a block diagram illustrating an example of the change in the content of the control by the control unit of the EMS.

FIG. 11 is a block diagram illustrating an example of the change in the content of the control by the control unit of the EMS.

FIG. 12 is a block diagram illustrating an example of a control logic for distributing a command value.

FIG. 13 is a diagram illustrating an example of a hardware configuration of the EMS.

### DETAILED DESCRIPTION

Hereinafter, exemplary embodiments of the present disclosure will be described in detail with reference to the accompanying drawings. In addition, in the description of the drawings, the same elements are denoted by the same reference numerals, and the description thereof will not be repeated.

### Power Supply System

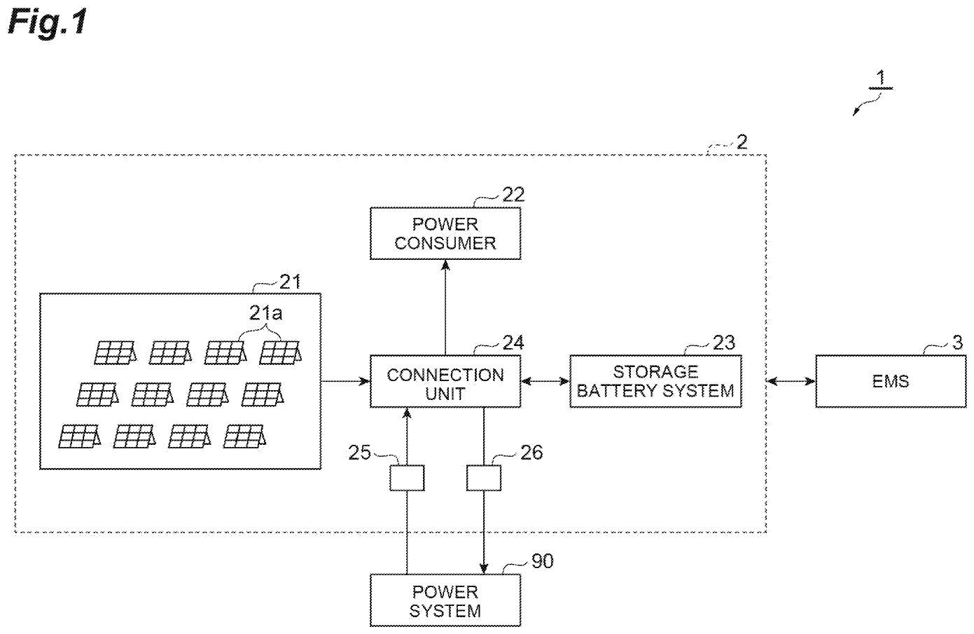

FIG. 1 is a diagram schematically illustrating a configuration of a power supply system 1 according to an embodiment. As illustrated in FIG. 1, the power supply system 1 includes a microgrid 2 and an energy management system 3 (Power control device). Hereinafter, the “energy management system” is referred to as an “EMS”. The microgrid 2 is configured to include a photovoltaic power generation facility 21, a power consumer 22, a storage battery system 23, a connection unit 24, a received power measurement unit 25, and a transmission power measurement unit 26.

The microgrid 2 is connected to an external power system 90 and can transmit and receive power to and from the power system 90. However, it is assumed that the microgrid 2 described in the following embodiment is not capable of transmitting power (reverse power flow) because of a contract with a power transmission and distribution company that operates the power system 90. More specifically, for example, it is assumed that a state in which received power is lower than 0 kW (power transmission state) is not maintained for 400 milliseconds or longer. However, it is assumed that power can be transmitted for a time shorter than 400 milliseconds. In addition, the above numerical values (for example, 0 kW and 400 milliseconds) are only examples, and a limit value of power or time differs for each contract.

In addition, a reverse power relay (RPR) is installed in order to prevent the reverse power flow from the microgrid 2, which is not illustrated in FIG. 1. The RPR prevents the reverse power flow by monitoring transmission power and transmits a signal when detecting the reverse power flow (in the example of this embodiment, a state in which the received power is lower than 0 kW is maintained for 400 milliseconds or longer) to operate a circuit breaker of the photovoltaic power generation facility 21. However, in a case in which the RPR is operated, the RPR forcibly stops photovoltaic power generation. Therefore, in the following embodiment, a configuration for operating the storage battery system 23 to prevent the RPR from performing an operation of stopping photovoltaic power generation, that is, to prevent the RPR from detecting the reverse power flow will be described.

The photovoltaic power generation facility 21 is an example of a renewable energy power generation device. The photovoltaic power generation facility 21 is a photovoltaic (PV) power generation system and includes a photovoltaic panel 21a and a power conditioning system (PCS) (not illustrated). In some cases, the power conditioning system is called a PV-PCS. The PV-PCS converts a direct current into an alternating current.

In addition, in the present disclosure, the type of the renewable energy generation facility is not limited to photovoltaic power generation. For example, the renewable energy generation facility may be a wind power generation system, a geothermal power generation system, a biomass power generation system, or a waste power generation system. Further, in the case of photovoltaic power generation, the amount of power generated fluctuates under the influence of weather conditions (solar radiation, temperature, and snowfall). Further, the configuration of the present disclosure can be implemented even in a case in which the facilities related to power generation are not present in the microgrid 2. However, the configuration described in the present disclosure has the effect of suppressing disturbance elements (variable factors in the amount of power generated in the renewable energy power generation facility) for received power and transmission power. Therefore, when the configuration is applied to the microgrid 2 including a power facility having variable output power, the configuration is more effective.

In the case of photovoltaic power generation among the power generation methods using renewable energy, the amount of power generated fluctuates under the influence of weather conditions (solar radiation, temperature, and snowfall). Further, in the case of wind power generation, the amount of power generated fluctuates under the influence of a wind speed. In addition, in biomass power generation or waste power generation, the properties of biomass or waste (for example, waste products or sludge), which are raw materials, are generally not stable, and an output is not stable due to, for example, the temporary contamination by substances unsuitable for incineration. Therefore, the above-mentioned power generation method is a method to which the technique described in the present disclosure is effectively applied, similarly to the photovoltaic power generation.

The power consumer 22 is a set of facilities that consume power. For example, in the power supply system 1 according to this embodiment, the power consumption of the power consumer 22 may be the sum of the power consumption of each device, such as a server and a display, constituting the EMS 3 that controls the microgrid 2, the power consumption of air conditioning facilities, the power consumption of lighting facilities in an institution, and the power consumption of security devices (for example, monitoring cameras). In addition, the power consumer 22 may include low-voltage consumers such as general households. Further, it is assumed that the EMS 3 is not capable of controlling the power consumption of the power consumer 22.

The storage battery system 23 is an example of an energy storage device. The storage battery system 23 is configured to include a storage battery. The storage battery is a secondary battery such as a lithium-ion battery, a lead battery, or a redox flow battery. In addition, the storage battery may be an energy storage device, such as a flywheel/compressed air energy storage (CAES) facility or a large-capacity capacitor, in addition to the secondary battery. Further, it is assumed that the storage battery system 23 also includes a storage battery PCS that converts a direct current of the storage battery into an alternating current and a device for monitoring a remaining storage battery level. The storage battery system 23 can function as a power adjustment device when power exchange between the microgrid 2 and the outside thereof is adjusted.

The connection unit 24 has a function of distributing power to each unit including the external power system 90. The connection unit 24 is, for example, a distribution board. For example, the connection unit 24 controls the distribution of power to each unit on the basis of an instruction from the EMS 3.

The received power measurement unit 25 and the transmission power measurement unit 26 measure the power received from and transmitted to the external power system 90, respectively. In this embodiment, the received power measurement unit 25 and the transmission power measurement unit 26 may be collectively referred to as a power measurement unit. In addition, since the power supply system 1 according to this embodiment uses the received power and the transmission power as a control amount, it is desirable that the received power and the transmission power are measured at a relatively short measurement cycle (in units of milliseconds).

### EMS (Power Control Device)

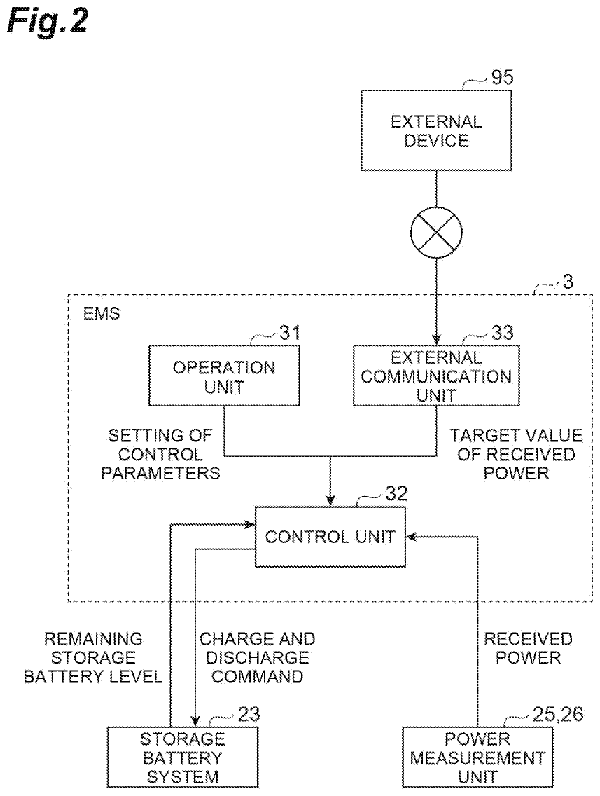

FIG. 2 is a diagram illustrating the EMS 3 that monitors the movement and exchange of power in the microgrid 2. That is, the EMS 3 functions as a device for controlling power in the microgrid 2. However, in FIG. 2, only functional units issuing control commands to the storage battery system 23 which arc intended by the present disclosure among various functions of the EMS 3 are illustrated. That is, the other functions of the EMS 3, such as a database function and a demand monitoring function, are omitted.

As illustrated in FIG. 2, the EMS 3 includes an operation unit 31, a control unit 32, and an external communication unit 33.

The operation unit 31 has, for example, a function of being operated by, for example, an operator of the EMS 3 (for example, a plant operator) to input various types of information. For example, the operation unit 31 may include a monitor and a keyboard. The information input by the operation unit 31 is various parameters (control parameters) related to the control of the EMS 3 and includes, for example, gains and threshold values. The information input by the operation unit 31 is transmitted to the control unit 32. In addition, the control parameters are illustrated in Table 1 which will be described below

The control unit 32 has a function of transmitting a charge and discharge command to the storage battery system 23 in the microgrid 2 to control the charge and discharge of the storage battery system 23. The control unit 32 acquires the control parameters specified by the operator through the operation unit 31 and also acquires a received power target value through the external communication unit 33 which will be described below. In addition, the control unit 32 acquires a remaining storage battery level (the amount of power stored in the storage battery) from the storage battery system 23 and also acquires information related to the received power from the power measurement unit (the received power measurement unit 25 and the transmission power measurement unit 26). The control unit 32 determines a command to be issued as the charge and discharge command to the storage battery system 23 on the basis of these information items and transmits the command to storage battery system 23.

The external communication unit 33 has, for example, a function of communicating with an external device 95 such as a power provider or a resource aggregator. An example of the information acquired by the external communication unit 33 from the external device 95 is the received power target value. In addition, the received power target value may be information that is provided from the external device 95 or may be information that is input by the operator through the operation unit 31.

A basic policy of power control for the microgrid 2 by the control unit 32 will be described. As a premise, in a case in which the microgrid 2 procures power from a power market or receives power using a self-consignment system, it is necessary to match the amount of power received during 30 minutes with a value planned in advance (planned value). This is because the difference between the plan and the actual result is billed as an imbalance penalty charge by general power transmission and distribution companies. As described above, in a case in which it is necessary to match the amount of received power with the planned value, the control unit 32 of the EMS 3 converts the received power planned value (unit: kWh) into the received power target value (unit: kW) and always performs constant received power control, that is, control to keep the power received by the microgrid 2 from the external power system 90 at a constant value.

In addition, the EMS 3 may receive a power adjustment command (demand response: DR) from the external device 95, such as a power provider or a resource aggregator, and perform the constant received power control temporarily (for several minutes to several hours). In this case, the microgrid 2 provides adjusting power to the power market.

As described above, the EMS 3 described in this embodiment may always perform the constant received power control or may temporarily perform the constant received power control.

In a case in which the received power is controlled. in this way, the control unit 32 of the EMS 3 outputs the charge and discharge command to the storage battery system 23 on the basis of the given received power target value.

### Content of Control by Control Unit

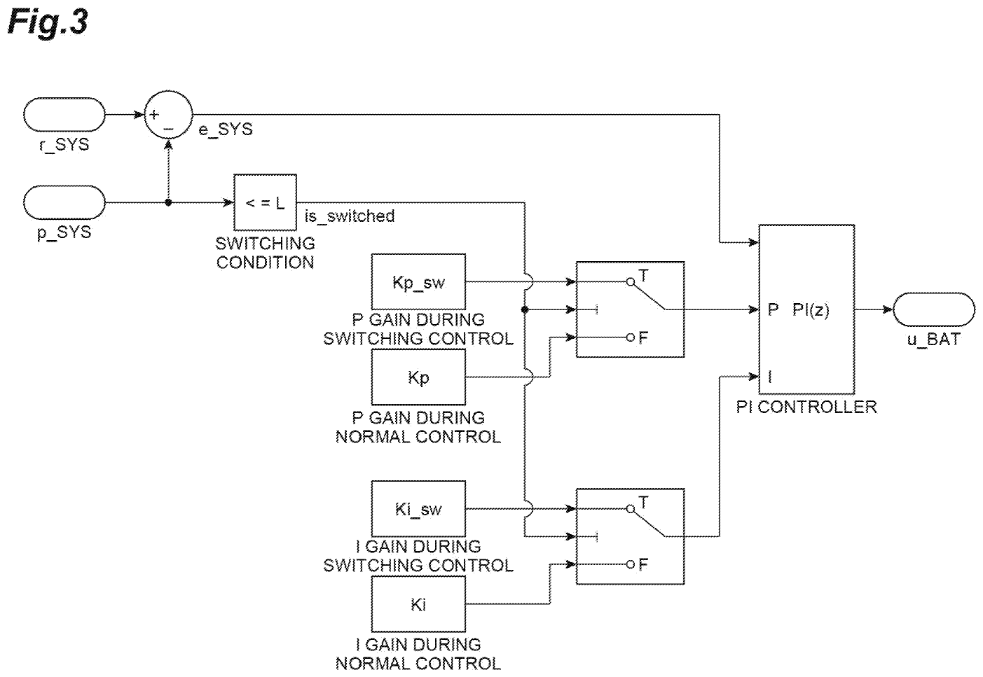

The specific content of the control by the control unit 32 will be described with reference to FIG. 3. The content of the control performed by the control unit 32 includes feedback control. Therefore, a block diagram illustrated in FIG. 3 includes a PI controller.

First, symbols used in the block diagram illustrated in FIG. 3 and the description thereof are illustrated in Table 1.

TABLE 1
Input signal from upper device

| | |
|---|---|
| r_{SYS} | Received power target value [unit: kW] |
| | (Power reception is positive, and power transmission is |
| | negative) |

Input signal from power measurement unit

| | |
|---|---|
| p_{SYS} | Measured values of received power and transmission |
| | power [unit: kW] |
| | (Power reception is positive, and power transmission is |
| | negative) |

Internal signal of control unit

| | |
|---|---|
| e_{SYS} | Deviation between received power target value and |
| | received power |
| is_switched | Boolean signal indicating gain switching |
| | (True: with switching, False: without switching) |

Output signal of control unit

| | |
|---|---|
| μ_{BAT} | Charge and discharge power command value to storage |
| | battery system [unit: kW] |
| | (Charge is positive, and discharge is negative) |

Parameters in control unit

| | |
|---|---|
| L | Received power threshold value for gain switching |
| Kp | Proportional gain (P gain) of PI controller during normal |
| | control |
| Ki | Integral gain (I gain) of PI controller during normal |
| | control |
| Kp_{sw} | Proportional gain (P gain) of PI controller during |
| | switching control |
| Ki_{sw} | Integral gain (I gain) of PI controller during switching |
| | control |

In addition, the PI controller included in FIG. 3 is a controller that is indicated by a discrete-time transfer function represented by the following Expression (1). Among the signals illustrated in Table 1, five parameters (L, Kp, Ki, Kp_sw, and Ki_sw) described as the parameters in the controller are control parameters that can be set by the operator, and the received power target value r_SYS is information that is input from the operator or the external device 95.

$$\begin{matrix}[ Expression 1 ] & \\ P I ( z ) = P + I \cdot {T}_{s} \frac{1}{z - 1} & ( 1 )\end{matrix}$$

Further, in Expression (1), P is the proportional gain, I is the integral gain, Tₛ is an operation cycle [seconds] of the controller, and z is a complex number.

In addition, the P gain of the PI controller during switching control can be set to be higher than the P gain of the PI controller during normal control. Further, the I gain of the PI controller during switching control can be set to be higher than the I gain of the PI controller during normal control. The switching control will be described in detail below. The P gain and the I gain during switching control are gains that are used in the PI controller in a case in which the received power in the microgrid 2 is equal to or less than 0 kW and gains for quickly returning to a state in which the received power is greater than 0 kW. Therefore, both the P gain and the I gain can be set to values that are larger than those during normal control. However, instead of setting both the P gain and the I gain to be larger than those during normal control, only one of the P gain and the I gain may be set to be larger than that during normal control.

The control by the control unit 32 will be described using the block diagram illustrated in FIG. 3.

As illustrated in FIG. 3, the control unit 32 calculates charge and discharge power (u_BAT) using the measured value (p_SYS) and the target value (r_SYS) of the received power. However, in a case in which the power generated by the photovoltaic power generation facility 21 in the microgrid 2 or the power consumption of the power consumer 22 fluctuates, the received power deviates from the target value of the received power. Therefore, the control unit 32 calculates the deviation (e_SYS) between the measured value (p_SYS) and the target value (r_SYS) of the received power and creates a charge and discharge command with the PI controller.

Here, the control unit 32 switches the content of the control of the PI controller using the threshold value L. Specifically, in a case in which the measured value (p_SYS) of the received. power is equal to or less than the threshold value L, the P gain and the I gain of the PI controller are switched, and the P gain during switching control and the I gain during switching control are used. In addition, in a case in which the measured value (p_SYS) of the received power is greater than the threshold value L, the initial gains, that is, the P gain during normal control and the I gain during normal control are used. The threshold value L is set between the received power target value (r_SYS) and a received power of 0 kW by the operator. Further, the threshold value L may be automatically determined by the control unit so as to be between 0 and the received power target value (r_SYS). For example, the threshold value L may be determined as in the following Expression:

L=r_SYS/2.

A block for switching between the P gain and the I gain is described on the upstream side of the PI controller. In other words, it is shown that the P gain and I gain used in the PI controller are selected according to a magnitude relationship between the measured value (p_SYS) of the received power and the threshold value L and are transmitted to the PI controller.

In the PI controller, a state in which the P gain during switching control and the I gain during switching control are used is a state in which the content of feedback control is changed from a state in which the P gain during normal control and the I gain during normal control are used. In other words, in the state in which the P gain during switching control and the I gain during switching control are used, the feedback control of the PI controller is performed under a condition different from that in the state in which the P gain during normal control and the I gain during normal control are used, that is, under a second condition. As described above, control to change the content of the feedback control is referred to as change control.

The above-described content of the control differs from general PI control according to the related art in that the P gain and the I gain used in the PI controller are switched on the basis of the threshold value. As described above, the P gain and the I gain during switching control are set to be higher than the P gain and the I gain during normal control. Therefore, the content of the control is that, during switching control, the amount of change in the deviation (e_SYS) between the measured value (p_SYS) and the target value (r_SYS) of the received power is larger than that during normal control.

### Simulation and Results Thereof

As described in this embodiment, how the amount of power stored in the storage battery system 23 is controlled and how the actual power exchange between the microgrid 2 and the external power system 90 is changed by the addition of the configuration for switching the gains of the PI controller were simulated under the following conditions:
Power generated by photovoltaic power generation: Rated 1250 kW
Power measurement unit:
   Measurement waste time: 40 ins
   Addition of suitable white noise
Controller:
   Control cycle: 40 ms
   Received power target value r_SYS: 50 kW
   Control parameters of controller
      L: 30
      Kp: −0.4
      Ki: −5
      Kp_sw: −0.7
      Ki_sw: −13

Among the above-described conditions, the measurement waste time is a delay time until a measurement result of a measurement device is transmitted to the controller. In general, there is a delay in a measurement operation of the measurement device, and a communication delay may occur even until the value measured by the measurement device is transmitted to the control device (mostly a digital device). The sum of these delay times is the measurement waste time.

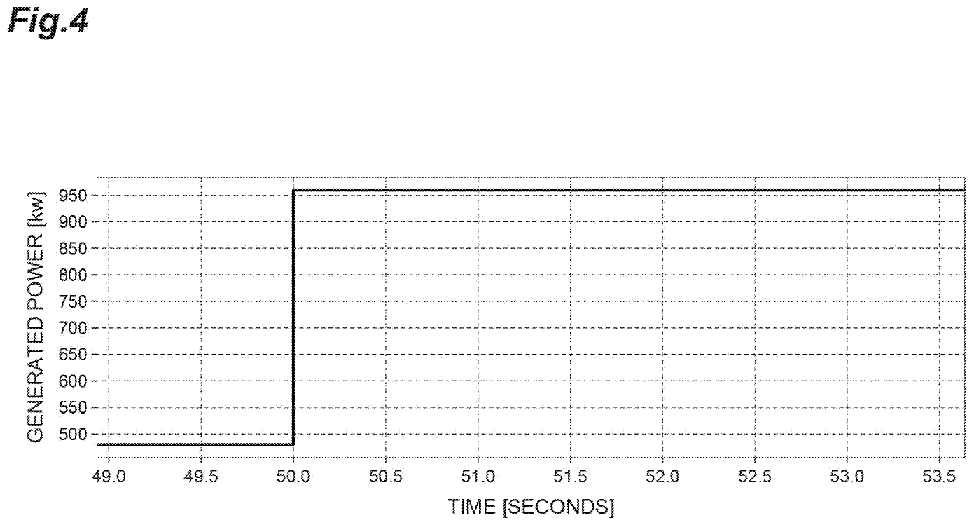

The power consumption of the power consumer 22 in the microgrid 2 was fixed at 600 kW during the simulation. In addition, as illustrated in FIG. 4, for the power generated by the photovoltaic power generation facility 21, assuming a situation in which the generated power suddenly changed due to the influence of clouds, the generated power was suddenly changed from 480 kW to 960 kW at 50 seconds after the start of the simulation. The power charged and discharged in the storage battery of the storage battery system 23 at this time and system power (power transferred to and from the external power system 90) were calculated by the simulation. In addition, as a control method by the control unit 32, two types of control methods, that is, the method according to this embodiment illustrated in FIG. 3 and the method according to the related art in which the P gain and the I gain are not switched in the PI controller as compared to the method according to this embodiment were simulated, and the simulation results were compared.

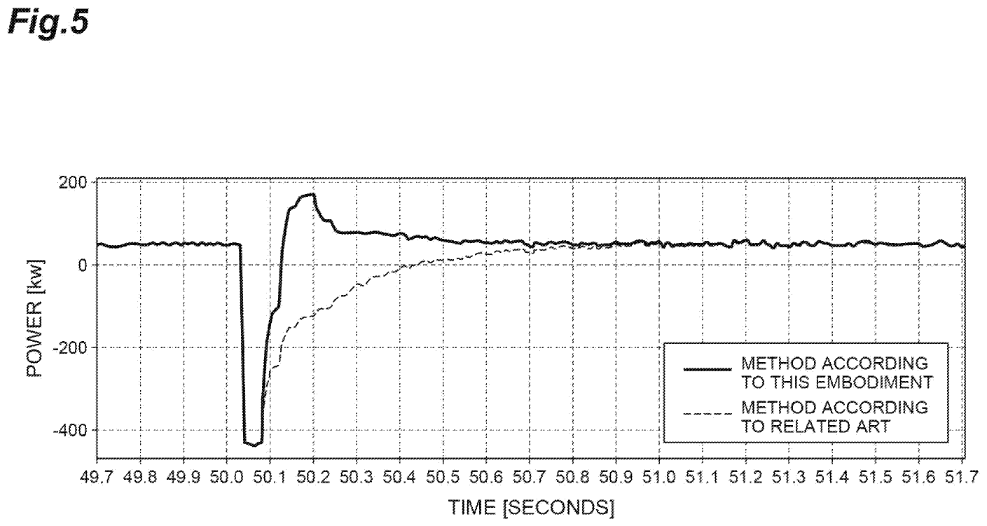

The results of the above-described simulation are illustrated in FIGS. 5 to 7.

FIG. 5 illustrates the simulation results of received power and transmission power. The horizontal axis is a simulation time [unit: seconds], and the vertical axis is power [unit: kW]. In addition, for the power on the vertical axis, a positive value means power reception and a negative value means power transmission.

In both the method according to this embodiment and the method according to the related art, the temporary transition of the received power to the power transmission side occurs at 50 seconds due to a rapid increase in power obtained by photovoltaic power generation. However, it can be seen that the received power is returned to a target value of 50 kW by the elect of the feedback control by the PI controller.

However, the results illustrated in FIG. 5 show that, while the duration of a state in which the received power is equal to or less than 0 kW is about 0.4 seconds in the method according to the related art, the duration of the state in which the received power is equal to or less than 0 kW is suppressed to about 0.1 seconds in the method according to this embodiment.

As described above, the microgrid 2 is set such that the RPR is operated when the duration of a power transmission state is longer than 400 milliseconds, that is, 0.4 seconds. Therefore, in the case of the control in the method according to the related art, it can be seen that there is a high risk that the photovoltaic power generation facility 21 will be blocked by the RPR. In a case in which the received power target value is set to 50 kW as described above, when a sudden change in power obtained by photovoltaic power generation occurs as illustrated in FIG. 4, there is a probability that the time from the transition of the received power to the power transmission side to the transition of the received power to the power reception side will satisfy the operation conditions of the RPR. That is, in order to shorten the state in which the received power is equal to or less than 0 kW, it is necessary to increase the received power target value to a larger value and to reduce the transmission power that can be generated in a case in which the power obtained by photovoltaic power generation rapidly increases.

On the other hand, in the method according to this embodiment, the transmission power at the time when the power obtained by photovoltaic power generation rapidly increases is about the same as that in the method according to the related art, but the received power is returned from a power transmission state to a power reception state, that is, a state in which the received power exceeds 0 kW in a shorter period of time than that in the method according to the related art. In the case of the method according to this embodiment, in a case in which the measured value of the received, power is less than the threshold value, the gains (the P gain and the I gain) can be increased to return the received power to the power reception side more quickly than that in the method according to the related art. Therefore, according to the method of this embodiment, it is possible to more reliably prevent the reverse power flow.

In addition, even in the controller in the method according to the related art, there is room for setting the P gain and the I gain to large values to shorten the duration of the power transmission state at the time of the transition of the received power to the power transmission side. However, it is generally known that, when the gain is increased too much in the PI controller, control becomes oscillatory and diverges in the worst case. Therefore, it is considered that it is difficult for the operator to respond by simply increasing the overall gain in the method according to the related art.

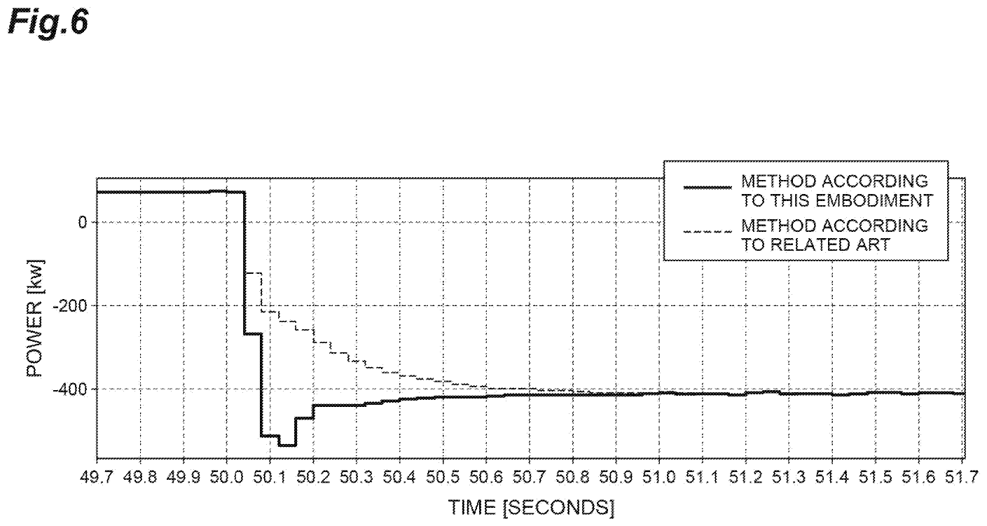

FIG. 6 illustrates the simulation. results of the charge and discharge power of the storage battery included in the storage battery system 23. The horizontal axis is a simulation time [unit: seconds], and the vertical axis is power [unit: kW]. In addition, for the power on the vertical axis, a positive vale means discharge and a negative value means charge.

According to the results illustrated in FIG. 6, in both the method according to this embodiment and the method according to the related art, the state of the storage battery changes from discharge to charge at 50 seconds when the power obtained by photovoltaic power generation changes suddenly. However, it was confirmed that, in the method according to this embodiment, charge and discharge changed more suddenly than that in the method according to the related art.

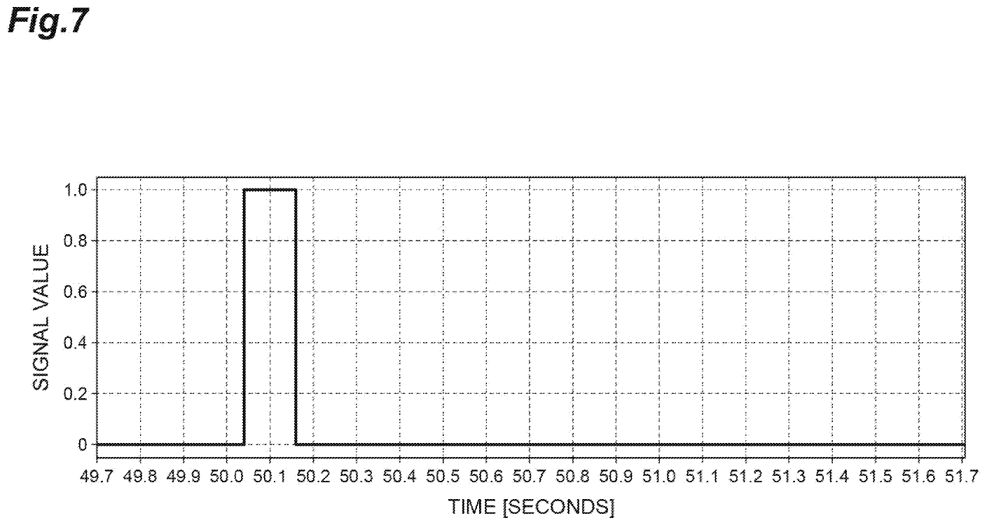

FIG. 7 illustrates a boolean signal meaning that the measured value of the received power is less than the threshold value and illustrates the time when the “is_switched” signal described above is issued. The gains of the PI controller are switched to the P gain during switching control and the I gain during switching control only for a period of time for which the signal value illustrated in FIG. 7 is 1. As illustrated in FIG. 7, the period of time for which the gains are switched is a little over 0.1 seconds and is very short. Therefore, control is prevented from oscillating or being unstable due to the switching of the gains. This is also clear from the results illustrated in FIG. 5.

### Modification Examples of Content of Control

In the above-described embodiment, the case has been described in which the reverse power flow from the microgrid 2 is prevented by changing the P gain and the I gain in the PI controller. However, a method for changing the content of the control of the PI controller is not limited to the switching operation.

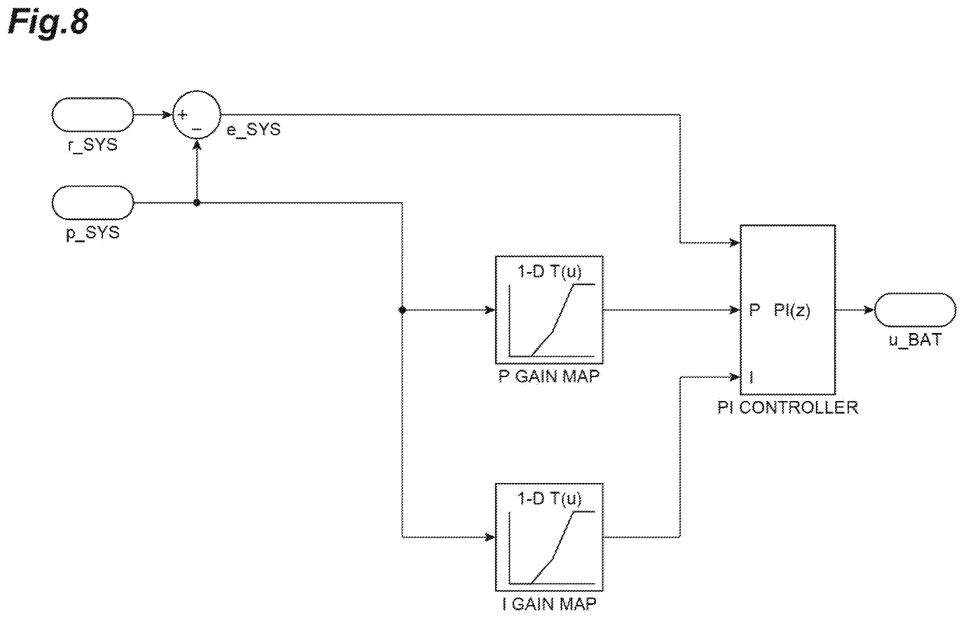

For example, the P gain and the I gain may be continuously changed according to a reduction in the received power to change the operation of the PI controller such that the action of the PI controller is strengthened, that is, the amount of change in the deviation is increased. FIG. 8 is a block diagram assuming that the control unit 32 performs the above-described control. A P gain map and an I gain map illustrated in FIG. 8 are maps for determining the P gain and the I gain according to the measured value (p_SYS) of the received power, respectively.

The P gain map and the I gain map can be changed as appropriate. In a case in which the gain is set such that the gain is kept constant when the measured value (p_SYS) of the received power exceeds the threshold value L and the gain becomes higher as the measured value of the received power becomes equal to or less than the threshold value L (in the example of this embodiment, an absolute value becomes a larger negative value), it is possible to perform almost the same control as that to change the content of the control using the threshold value L as the boundary as in the above-described embodiment.

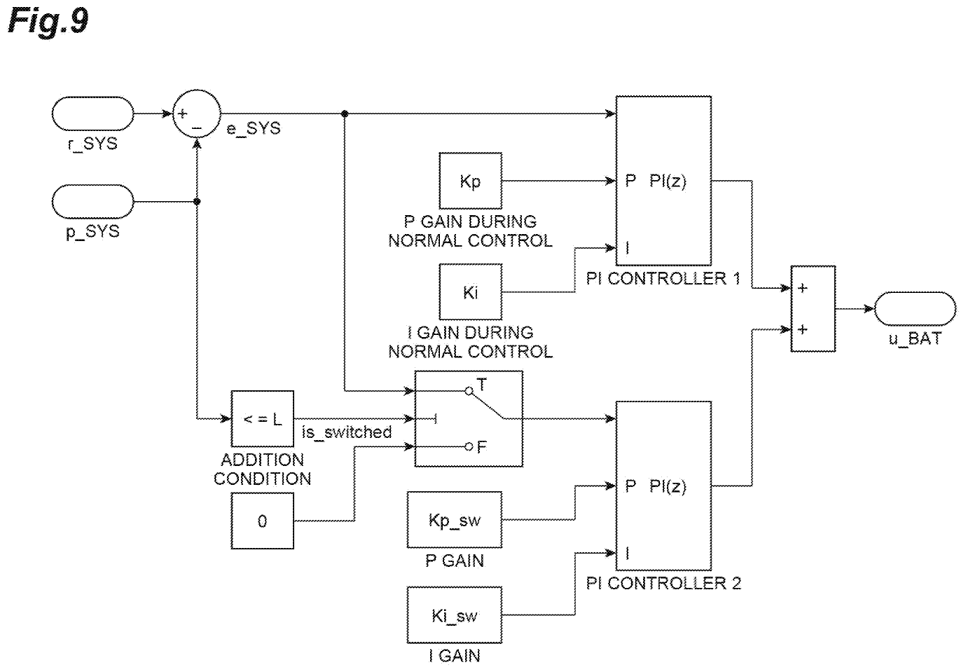

Further, instead of switching or continuously changing the gains of the PI controller to prevent the reverse power flow, another controller may be combined as illustrated in FIG. 9. In addition to PI controller 1 that is normally used, PI controller 2 that calculates a gain for addition in a case in which the measured value (p_SYS) of the received power is equal to or less than the threshold value L is provided. The sum of the calculation result of the PI controller 1 and the calculation result of the PI controller 2 is the charge and discharge power command value (u_BAT). In a case in which the measured value (p_SYS) of the received power exceeds the threshold value L, a value of 0 is input to the PI controller 2. Therefore, no results are output from the PI controller 2. On the other hand, when the measured value (p_SYS) of the received power is equal to or less than the threshold value L, the deviation (e_SYS) is input, and an adjustment value is calculated using the P gain and the I gain for calculating an addition signal to be added to the charge and discharge command. As a result, in a case in which the measured value (p_SYS) of the received power is equal to or less than the threshold value L, the calculation result using the gains during normal control, which has been calculated by the PI controller 1, and the addition signal output from the PI controller 2 are combined, which makes it possible to perform control to increase the amount of change in the deviation and to perform the same control as that in the example illustrated in, for example, FIG. 8.

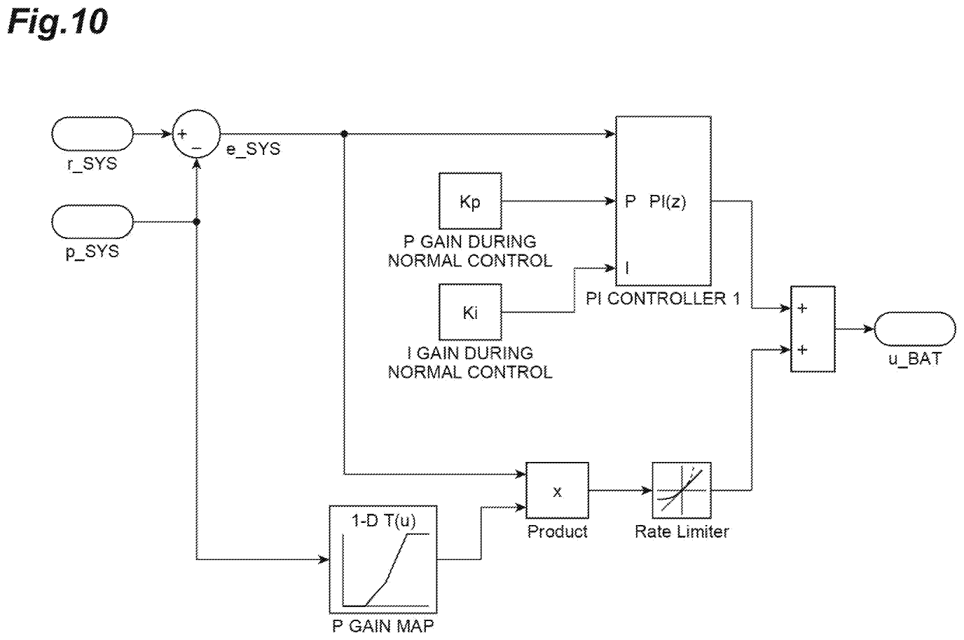

Representative examples of the method that changes the content of the control by the PI controller in order to reduce the deviation (e_SYS) between the measured value (p_SYS) and the target value (r_SYS) of the received power have been described with reference to, for example, FIGS. 3, 8, and 9. However, the above-described methods may be combined as appropriate. For example, in an example illustrated in FIG. 10, instead of the PI controller 2 illustrated in FIG. 9, a controller using the P gain map that changes the P gain according to the measured value (p_SYS) of the received power is provided. In addition, a change rate limiter (rate limiter) is provided at the final stage of calculation related to the addition signal using the P gain map. The change rate limiter illustrated in FIG. 10 is set so as not to impose a change rate limit on the movement of an increase in charge (decrease in discharge), which prevents the reverse power flow, and to impose a change rate limit on the movement of a decrease in charge (increase in discharge) after the reverse power flow is prevented (after the received power becomes sufficiently high). A change rate limit value is, for example, 10 kW/s.

The change rate limiter is inserted. to suppress the oscillation of the charge and discharge command for the storage battery. The provision of the change rate limiter makes it possible to rapidly change the charge and discharge command value to reliably prevent the occurrence of the reverse power flow in a case in which the reverse power flow is likely to occur and to gently end the control to prevent the reverse power flow, that is, the control using the P gain map after the received power is recovered (becomes sufficiently high). Therefore, the effect of preventing unnecessary charge and discharge in the storage battery system 23 is obtained by providing the change rate limiter.

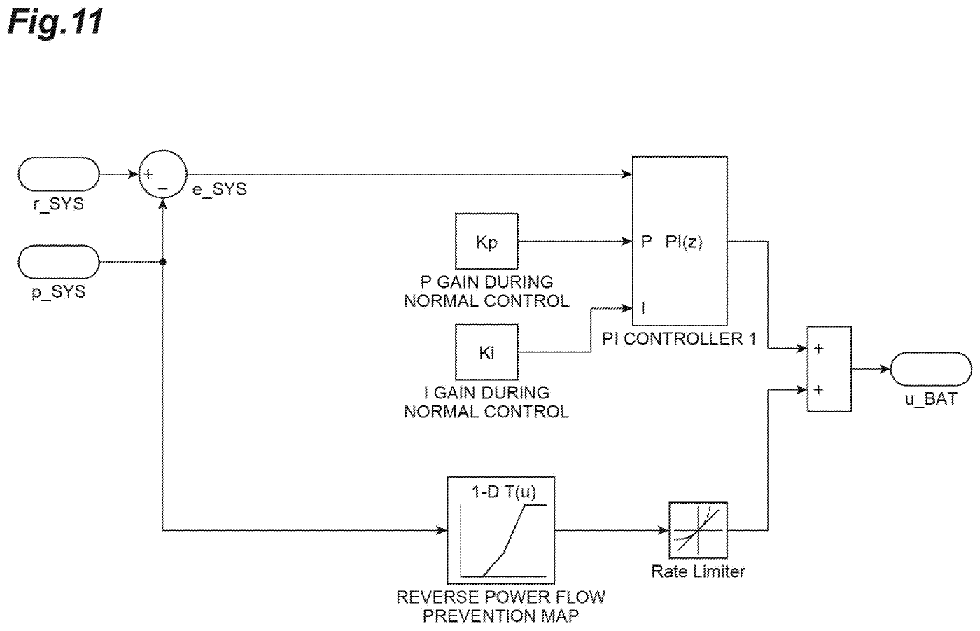

Further, in FIG. 10, the two values of the deviation (e_SYS) and the measured value (p_SYS) of the received power are input when the calculation related to the addition signal is performed. However, only one of the values may be used. For example, in an example illustrated in FIG. 11, only the measured value (p_SYS) of the received power is input, and the addition signal is generated using a reverse power flow prevention map and a change rate limiter disposed in a stage behind the reverse power flow prevention map. This configuration makes it possible to shorten the calculation time required to calculate the charge and discharge power command value (u_BAT).

Further, in the above-described examples, the case in which charge and discharge are performed in the storage battery system 23 to adjust power in the microgrid 2 has been described. However, the functions of the power adjustment device related to the adjustment of the power exchange between the microgrid 2 and the external power system 90 may be implemented by devices other than the storage battery. For example, power may be adjusted by any one of a power consumption device, such as a water electrolysis device or an electric boiler, a power generation device, such as a fuel cell, and an energy storage device, such as a storage battery, or any combination thereof. In this case, the command value described as the charge and discharge power command value (u_BAT) in the block diagrams illustrated so far is distributed to each device having the power adjustment function in the microgrid 2 to determine the control value of each device.

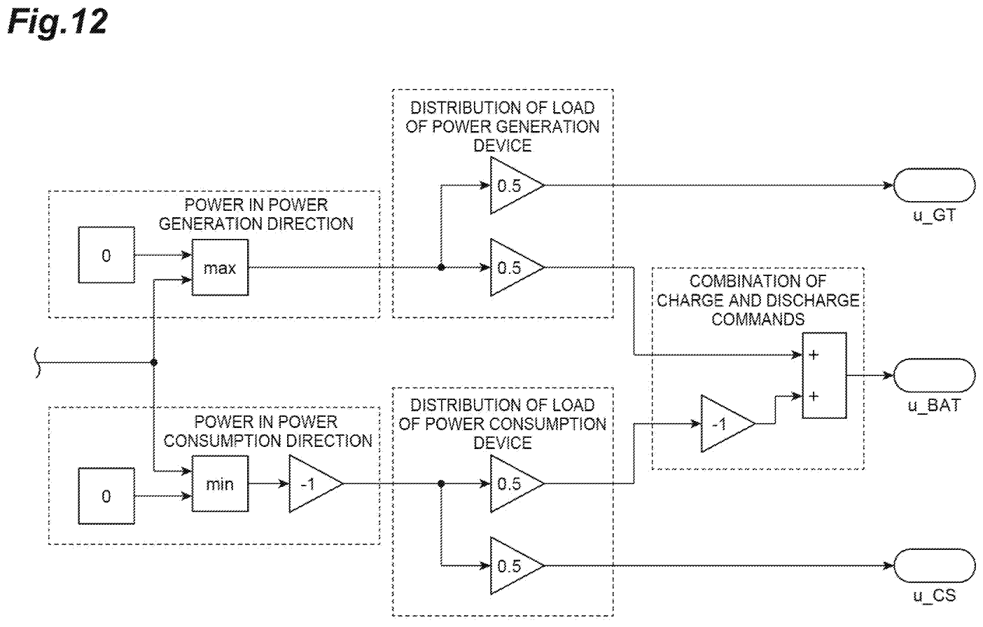

FIG. 12 illustrates an example of a control logic in a case in which the microgrid 2 includes a power generation device, a power consumption. device, and a storage battery as the power adjustment devices. A command value u_GT included in FIG. 12 is a power generation command (having a positive value) for the power generation device, and a command value u_CS is a power consumption command (having a positive value) for the power consumption device.

In FIG. 12, for example, the operation based on the charge and discharge power command value (u_BAT) output from the PI controller in FIG. 3 is distributed to the power generation device, the power consumption device, and the storage battery. Therefore, it is assumed that the control logic illustrated in FIG. 12 is connected to a stage behind the PI controller illustrated in FIG. 3.

In a case in which three types of devices of the power generation device, the power consumption device, and the storage battery are provided as the power adjustment devices, the stage behind the PI controller separates the command values output from the PI controller into a command in a power generation direction and a command in a power consumption direction. For example, in a case in which a power command value in the power generation direction is transmitted, a positive value corresponding to the command value is given as power in the power generation direction, and 0 is given as power in the power consumption direction. Therefore, the command value (u_CS) for the power consumption device in the subsequent stage is 0. In a case in which a power command value in the power consumption direction is transmitted, a positive value corresponding to the command value is given as the power in the power consumption direction, and 0 is given as the power in the power generation direction. Therefore, the command value (u_GT) for the power generation device in the subsequent stage is 0.

In addition, in a case in which the power command value in the power generation direction is transmitted, a power load is distributed between the power generation device and the storage battery (FIG. 12 illustrates that the power load is evenly distributed by 0.5). On the other hand, in a case in which the power command value in the power consumption direction is transmitted, a power load is distributed between the storage battery and the power consumption device. Since the storage battery can be charged and discharged, the charge and discharge command value (u_BAT) can be created by combining the load in the power generation direction and the load in the power consumption direction.

The preparation of the logic for distributing the command value illustrated in FIG. 12 makes it possible to distribute the power load based on the command value between the devices in a case in which there are a plurality of power adjustment devices. In addition, in the power generation device and the power consumption device, the commands may be proportionally divided at a ratio corresponding to the number of devices or at a ratio corresponding to the rating of the devices. Further, one power generation device, one power consumption device, and one storage battery may be provided, or a plurality of power generation devices, a plurality of power consumption devices, and a plurality of storage batteries may be provided. Furthermore, in the above-described embodiment, the description has been made on the assumption that there is one storage battery. However, a plurality of storage batteries may be provided. In this case, similarly to the logic illustrated in FIG. 12, a power load is distributed among the devices of the same type to accommodate for a plurality of devices.

In addition, a configuration in which there is one power generation device (or one power consumption device) may be used. The power to be constantly adjusted is fixed in the power generation direction (or the power consumption direction) by the setting of a power target value in the upper system and the control of the control unit 32 based on the parameters, which makes it possible to achieve constant power control even with one power generation device (or one power consumption device).

### Hardware Configuration

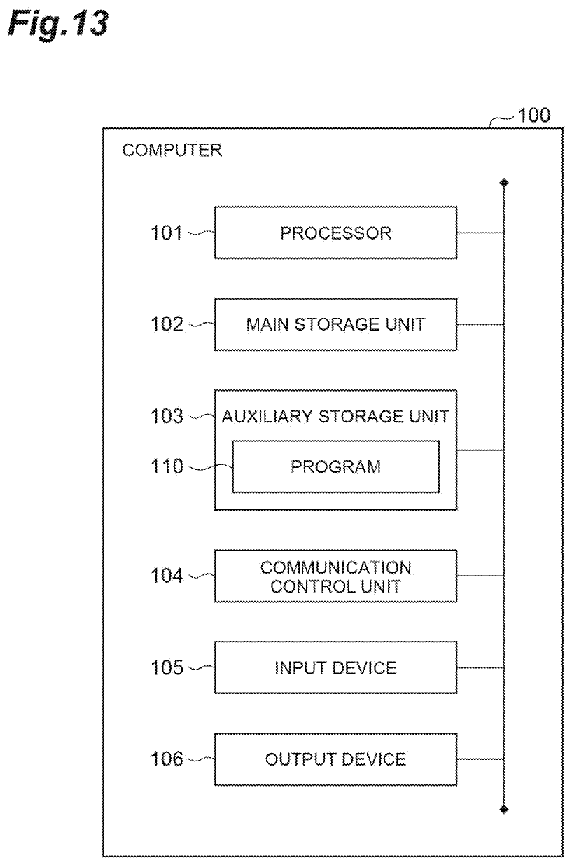

A hardware configuration of the EMS 3 will be described with reference to FIG. 13. FIG. 13 is a diagram illustrating an example of the hardware configuration of the EMS 3. The EMS 3 includes one or more computers 100. The computer 100 has a processor 101, a main storage unit 102, an auxiliary storage unit 103, a communication control unit 104, an input device 105, and an output device 106. The EMS 3 is composed of one or more computers 100 composed of these hardware components and software such as programs.

In a case in which the EMS 3 is composed of a plurality of computers 100, these computers 100 may be connected locally or through a communication network such as the Internet or an intranet. One EMS 3 is logically constructed by this connection.

The processor 101 executes, for example, an operating system or application programs. The main storage unit 102 is composed of a read only memory (ROM) and a random access memory (RAM). The auxiliary storage unit 103 is a storage medium composed of, for example, a hard disk and a flash memory. The auxiliary storage unit 103 generally stores a larger amount of data than the main storage unit 102. The communication control unit 104 is configured by a network card or a wireless communication module. At least some of the communication functions of the EMS 3 with other devices may be implemented by the communication control unit 104. The input device 105 is composed of, for example, a keyboard, a mouse, a touch panel, and a voice input microphone. The output device 106 is composed of, for example, a display and a printer.

The auxiliary storage unit 103 stores a program 110 and data necessary for processes in advance. The program 110 causes the computer 100 to function as each functional element of the EMS 3. For example, the process related to the above-described power control method is performed in the computer 100 by the program 110. For example, the program 110 is read by the processor 101 or the main storage unit 102 and operates at least one of the processor 101, the main storage unit 102, the auxiliary storage unit 103, the communication control unit 104, the input device 105, and the output device 106. For example, the program 110 reads and writes data from and to the main storage unit 102 and the auxiliary storage unit 103.

The program 110 may be recorded on a tangible storage medium, such as a CD-ROM, a DVD-ROM, or a semiconductor memory, and then provided. The program 110 may be provided as a data signal through a communications network.

### Operation and Effect of Embodiment

In the EMS 3 as the power control device, the power control method, and the power control program, in the microgrid 2 that is capable of exchanging energy with the external power system 90 and includes the photovoltaic power generation facility 21 as a renewable energy power generation device and the storage battery system 23 as a power adjustment device that adjusts internal power usage, the operation of the storage battery system 23 is performed. In this case, the EMS 3 controls the storage battery system 23 such that the actual value of energy exchange with the outside is close to the target value. Specifically, feedback control is performed in the above-described embodiment. Furthermore, the EMS 3 includes the control unit 32 that performs change control to change the content of control such that the amount of change in the deviation increases in a case in which the state of the energy exchange changes such that the deviation between the target value and the actual value becomes larger.

In the method described in this embodiment, the control unit 32 of the EMS 3 performs the feedback control on the storage battery system 23 as the power adjustment device on the basis of the actual value and the target value of the energy exchange with the outside such that the actual value is close to the target value. Therefore, it is possible to stably adjust energy exchange with the outside. In addition, the control unit 32 of the EMS 3 performs the change control to change the content of the feedback control such that the amount of change in the deviation increases in a case in which the state of the energy exchange changes such that the deviation between the target value and the actual value becomes larger. Therefore, according to the above-described method, it is possible to rapidly return the received power in a case in which the deviation increases.

Further, the control unit 32 of the EMS 3 changes the content of the feedback control, that is, the gain in the condition in which the reverse power flow occurs. That is, the change control is performed in a case in which the actual value is on the side where energy exchange is switched with respect to the target value and the deviation between the target value and the actual value becomes larger. In a case in which the actual value is on the side where the energy exchange is switched with respect to the target value, for example, the risk that the switching of the energy exchange will occur increases. Therefore, it is necessary to quickly return the received power in a case in which the deviation increases.

On the other hand, in the above-described embodiment, in a case in which the actual value is on the side where the energy exchange is not switched with respect to the target value, the change control is not performed. In a case in which the actual value is on the side where the energy exchange is not switched, there is a probability that the control will be oscillatory due to the change control to increase the amount of change in the deviation. In addition, there is a probability that the switching of the energy exchange will occur due to the oscillation. Therefore, the above-described configuration makes it possible to adjust the energy exchange with the outside while suppressing the switching of the energy exchange as much as possible.

Further, in the above-described embodiment, from the viewpoint of preventing the reverse power flow, in a case in Which the actual value of the received power is less than the threshold value, the gains (the P gain and the I gain) are increased to return the received power to the power reception side more quickly than that in the method according to the related art. That is, the threshold value is set only in a case in which the received power is less than the target value (in a case in which the reverse power flow can occur). However, a separate threshold value may be set even in a case in which the actual value of the received power is larger than the target value, and control may be performed to increase the gain even in a case in which the received power is too large. That is, the change control to change the content of the feedback control for increasing the gains according to the deviation may be performed on both the upper side (the side where a numerical value is large) and the lower side (the side where a numerical value is small and the energy exchange is switched) of the target value.

The change control may be, for example, control that changes the content of the feedback control to the P gain during switching control and the I gain during switching control as the second condition in a case in which the deviation between the target value and the actual value is larger than the threshold value as illustrated in the block diagram of FIG. 3. This configuration makes it possible to change the content of the feedback control to the second condition with a focus on the relationship between the deviation and the threshold value. Therefore, it is possible to more easily determine whether or not to perform the change control. In addition, it is possible to more easily perform, for example, the calculation of the control value when a command is issued to the power adjustment device.

In addition, the change control may be, for example, control that continuously changes the content of the feedback control according to the deviation between the target value and the actual value as illustrated in the block diagram of FIG. 8. According to this configuration, for example, when the deviation increases, the content of the feedback control is continuously changed with the increase in the deviation. Therefore, it is possible to perform the feedback control under appropriate conditions corresponding to the magnitude of the deviation.

### MODIFICATION EXAMPLES

The present disclosure is not necessarily limited to the above-described embodiments, and various modifications can be made without departing from the gist of the present disclosure.

In the above-described embodiments, the term “power reception” is used, but is not necessarily limited to power at a contractual demarcation point of a certain facility (a microgrid or a building). The configuration according to the present disclosure can control power on a power line on the upstream side of a certain power adjustment device (for example, a power generation device, a power consumption device, or a storage battery).

In the above-described embodiments, the constant power control is performed on the received power such that the power reverse flow does not occur. However, the present disclosure is not limited to this configuration. The constant power control may be performed from an opposite viewpoint. That is, the constant power control may be performed such that the transmission power does not flow in the power receiving direction.

For example, it is assumed that a microgrid facility connected to a certain external power system includes a wind power generation facility, a water electrolysis device, and a storage battery. In this case, assuming that power always flows between the microgrid and the system in a power transmission direction (a direction from the microgrid to the system), it can be proved that all of hydrogen power generated by the water electrolysis device of the microgrid is power derived from wind power generation. As described above, in a case in which all of the power consumption of products is desired to be derived from renewable energy, there is a need to always supply power to the power transmission side. However, in a case in which the amount of power generated by renewable energy temporarily decreases, there is a probability that power between the microgrid and the system will change from power transmission to power reception. In this situation, the control by the power control device described in the above-described embodiments can be applied to effectively prevent unintended power reception. In this case, of course, the setting of the threshold value or the gains is changed from the conditions described in the above-described embodiments.

In addition to the control described in the above-described embodiments, a process that stops the feedback control as the protection stop of the storage battery when the power capacity of the storage battery in the storage battery system 23 is equal to or less than a certain value or is equal to or greater than the certain value may be combined. As described above, the control described in the above-described embodiments need not be performed alone or may be performed in combination with control that is not described in the above-described embodiments. For example, the content of the control is changed when the power adjustment device enters a specific state.

In the above-described embodiments, the feedback control has been described under the condition that the capacity of the storage battery of the storage battery system 23 is not particularly considered. However, the feedback control may be performed in consideration of the capacity of the storage battery. For example, a value obtained by adding the product of a difference between the remaining storage battery level of the storage battery and a desired remaining storage battery level (for example, 50%) and the proportional gain to an output value from the PI controller described in the embodiments may be used as the charge and discharge command value (u_BAT) (in this case, a bias is applied in the charge direction in a case in which the remaining storage battery level is less than the desired value and is applied in the discharge direction in a case in which the remaining storage battery level is greater than the desired value, and the command is output). In addition, the target value of the remaining storage battery level may be changed according to a period of time. For example, in a case in which an energy shift in which the storage battery is charged during the day and is discharged at night is desired to be performed on the storage battery, a curve may be used in which the target value of the remaining storage battery level gradually increases from sunrise to sunset and gradually decreases from sunset to sunrise on the next day. The target value of the remaining storage battery level may be manually set by the operator of the EMS 3 or may be given to the control unit 32 of the EMS 3 from another upper system that is determined by, for example, an optimization method.

In the above-described embodiments, the case in which the PI controller is used has been described. However, the feedback controller is not limited to the PI controller. The feedback controller may be other controllers that can be used for feedback control, such as a PID controller, a PD controller, an I-PD controller, and a two-degree-of-freedom PID controller. In addition, the controller may be designed using control theories such as an H2 control theory and an H∞ control theory. The parameters for determining the content of the control of the controller are changed depending on the type of controller. Further, the parameters can be adjusted according to, for example, the operating conditions of the microgrid 2. Furthermore, control other than the feedback control may be performed such that the actual value of the energy exchange with the outside is close to the target value.

Renewable energy may be other than photovoltaic power generation. In addition, even in a case in which there are a plurality of renewable energy power generation facilities and a plurality of types of renewable energy power generation facilities, the same control as that in the configuration described in the above-described embodiments can be performed by combining the renewable energy power generation facilities.

In the above-described embodiments, power has been described as alternating-current power. However, the received power and the transmission power as the control amount may be direct-current power. In a case in which the alternating-current power is used, for example, a capacitor for power factor control may be provided as a power facility.

As described above, the content of the control by the EMS 3 described in the above-described embodiments is characterized in that it is possible to keep the received power or the transmission power constant, in addition to preventing the reverse power flow. Therefore, even when there is variable renewable energy, power is constant at a power receiving point, and thus the variable renewable energy does not affect the system. Therefore, it can be considered that a power source with a constant output is connected when viewed from the power receiving point. Therefore, the content of the control by the EMS 3 described in the above-described embodiments is control that can also lead to the spread of a renewable energy power generation facility that has not spread due to unstable power-generating capacity which is one of the reasons why it is not popularized.

The reverse power flow is prevented by the output control of the power adjustment device described in the above-described embodiments. However, in some cases, the fluctuation of photovoltaic power generation exceeds the rating of the power adjustment device, and the reverse power flow occurs due to the performance of the device (it is not possible to prevent the reverse power flow only with the output control of the power adjustment device in principle). In this case, in addition to the control of the power adjustment device according to the present disclosure, the output of a power conditioner for photovoltaic power generation may be reduced step by step to suppress the power obtained by photovoltaic power generation.

### Supplementary Note

The present disclosure contributes to the spread of renewable energy in order to solve the problem of a system connection caused by unstable power generation of renewable energy. Therefore, the present disclosure also contributes to the following targets of the Sustainable Development Goals (SDGs) led by the United Nations.
Target 7.2 “Increase substantially the share of renewable energy in the global energy mix by 2030,”
Target 9.4 “By 2030, upgrade infrastructure and retrofit industries to make them sustainable, with increased resource-use efficiency and greater adoption of clean and environmentally sound technologies and industrial processes, with all countries taking action in accordance with their respective capabilities.”

What is claimed is:

1. A power control device that controls an operation of a power adjustment device in a microgrid capable of exchanging energy with an outside, the microgrid including the power adjustment device adjusting an internal power usage, the power control device comprising:
a control unit that controls the power adjustment device such that an actual value of the energy exchange with the outside is close to a target value and, in a case in which a state of the energy exchange changes such that a deviation between the target value and the actual value becomes larger, performs change control to change a content of control such that an amount of change in the deviation increases.

2. The power control device according to claim 1,
wherein the control unit performs the change control in a case in which the actual value is on a side where the energy exchange is switched with respect to the target value and the deviation between the target value and the actual value becomes larger.

3. The power control device according to claim 1,
wherein the change control is control to change the content of the control to a second condition in a case in which the deviation between the target value and the actual value is larger than a threshold value.

4. The power control device according to claim 1,
wherein the change control is control to continuously change the content of the control according to the deviation between the target value and the actual value.

5. A power control method that controls an operation of a power adjustment device in a microgrid capable of exchanging energy with an outside, the microgrid including the power adjustment device adjusting an internal power usage, the power control method comprising:
controlling the power adjustment device such that an actual value of the energy exchange with the outside is close to a target value; and
in a case in which a state of the energy exchange changes such that a deviation between the target value and the actual value becomes larger, performing change control to change a content of control such that an amount of change in the deviation increases.

6. A non-transitory storage medium storing a power control program that causes a computer to control an operation of a power adjustment device in a microgrid capable of exchanging energy with an outside, the microgrid including the power adjustment device adjusting an internal power usage, the power control program causing the computer to execute:
controlling the power adjustment device such that an actual value of the energy exchange with the outside is close to a target value; and
in a case in which a state of the energy exchange changes such that a deviation between the target value and the actual value becomes larger, performing change control to change a content of control such that an amount of change in the deviation increases.
